(19) United States
(12) Patent Application Publication
(10) Pub. No.: US 2006/0038395 A1
(43) Pub. Date: Feb. 23, 2006

(54) Note box

(76) Inventor: Selene Anderson-Thompson, Sodus, MI (US)

Correspondence Address: LITMAN LAW OFFICES, LTD, PO BOX 15035, CRYSTAL CITY STATION, ARLINGTON, VA, 22215, US

(21) Appl. No.: 11/190,843

(22) Filed: Jul. 28, 2005

Related U.S. Application Data
(60) Provisional application No. 60/602,657, filed on Aug. 19, 2004.

(51) Int. Cl. B42D 7/00

(52) U.S. Cl. 281/45

(57) ABSTRACT

The note box includes a housing and a door pivotally attached to the housing. A pad of paper and a writing instrument are secured within the housing. A back portion of the pad of paper may be inserted through a slot defined in a rear wall of the housing to secure the pad within the housing and to hold the pad upright. At least one strip of hook-and-loop fastening material may be affixed to the housing to secure the writing instrument within the housing. A transparent window is disposed within the door to allow a user to view the contents of the housing when the door to the housing is closed.

### CROSS-REFERENCE TO RELATED APPLICATION

This application claims the benefit of U.S. Provisional Patent Application Ser. No. 60/602,657, filed Aug. 19, 2004.

### BACKGROUND OF THE INVENTION

1. Field of the Invention

The present invention relates to a device for displaying and storing messages, and more particularly, to a note box having a pivotally mounted door through which the contents of a note pad stored inside the box may be observed. The note box can be hung either on or adjacent to an exterior door so that messages can be left by or to delivery persons and visitors.

2. Description of the Related Art

When a resident is not in, those wanting to visit or to deliver a package to the residence typically leave a note on the door of the residence. By the same token, sometimes the resident must leave unexpectedly and wants to leave a note for an expected visitor, delivery person, or family member in a location where it will not be overlooked. Sometimes, however, a writing instrument and paper are not readily available for leaving a note. Even when a note is written, simply attaching a note to the door of the residence is not always advisable, since the note is exposed to the elements and may be damaged by rain or blown away by wind. While devices for displaying messages are known, there remains a need for a device that protects a message from damage or loss while at the same time displaying the message where it is readily visible and accessible.

U.S. Pat. No. 1,804,871, issued May 12, 1931 to H. H. Helland, discloses a device configured for positioning above the doorbell for callers to make notations of their visits. The device includes a frame on which a pad can be mounted with a cover, apparently opaque, that can be folded up to cover the pad. Loops extend outward from a side of the frame to receive a pen or pencil, which is otherwise exposed to the elements. The pad has a plurality of leaves attached thereto by perforations.

U.S. Pat. No. 6,032,855, issued Mar. 7, 2000 to B. F. Douglas discloses a message display apparatus for displaying messages. The apparatus includes a box-like case with a note pad attached to its front surface. The front surface of the body also has a drawer slidably inserted into the interior of the body and a slot providing an opening into the drawer.

Other devices for leaving notes or for boxes mounted on or adjacent to an exterior door are shown in U.S. Pat. No. 948,531, issued Feb. 8, 1910 to F. Stevenson (message recording device with notepad and writing implement); U.S. Pat. No. 1,199,136, issued Sep. 26, 1916 to H. H. Westphaln (mail-box with glass door); U.S. Pat. No. 5,000,380, issued Mar. 19, 1991 to G. R. Barrios (letter retaining and protecting device); U.S. Pat. No. 5,624,071, issued Apr. 29, 1997 to F. O. Sosan (method and apparatus for receiving packages); U.S. Pat. No. 5,655,323, issued Aug. 12, 1997 to S. I. Lassof (message board); and PCT Application No. WO 98/02369, published Jan. 22, 1998 (false front for a mailbox.

None of the above inventions and patents, taken either singly or in combination, is seen to describe the instant invention as claimed. Thus, a note box for attempted delivery solving the aforementioned problems is desired.

### SUMMARY OF THE INVENTION

The note box includes a box-shaped housing and a door pivotally attached to the housing. A pad of paper and a writing instrument are secured within the housing. A back portion of the pad of paper may be inserted through a slot defined in a rear wall of the housing to secure the pad within the housing and to hold the pad upright. At least one strip of hook-and-loop fastening material affixed to the housing may be wrapped around the writing instrument and used to secure the writing instrument within the housing. A transparent window is disposed within the door to allow a user to view the contents of the housing even when the door to the housing is closed.

The note box can be secured to an entry door or any suitable surface outside a residence so that messages can be conveniently stored and displayed for a resident. The note box is constructed from durable waterproof materials so that the note box can withstand adverse weather conditions.

These and other features of the present invention will become readily apparent upon further review of the following specification and drawings.

### BRIEF DESCRIPTION OF THE DRAWINGS

FIG. 1 is an environmental, front view of a note box according to the present invention.

FIG. 2 is an exploded perspective view of a note box according to the present invention.

FIG. 3 is a perspective view of a note box according to the present invention with the door in a closed position.

FIG. 4 is a rear perspective view of a note box according to the present invention.

Similar reference characters denote corresponding features consistently throughout the attached drawings.

### DETAILED DESCRIPTION OF THE PREFERRED EMBODIMENT

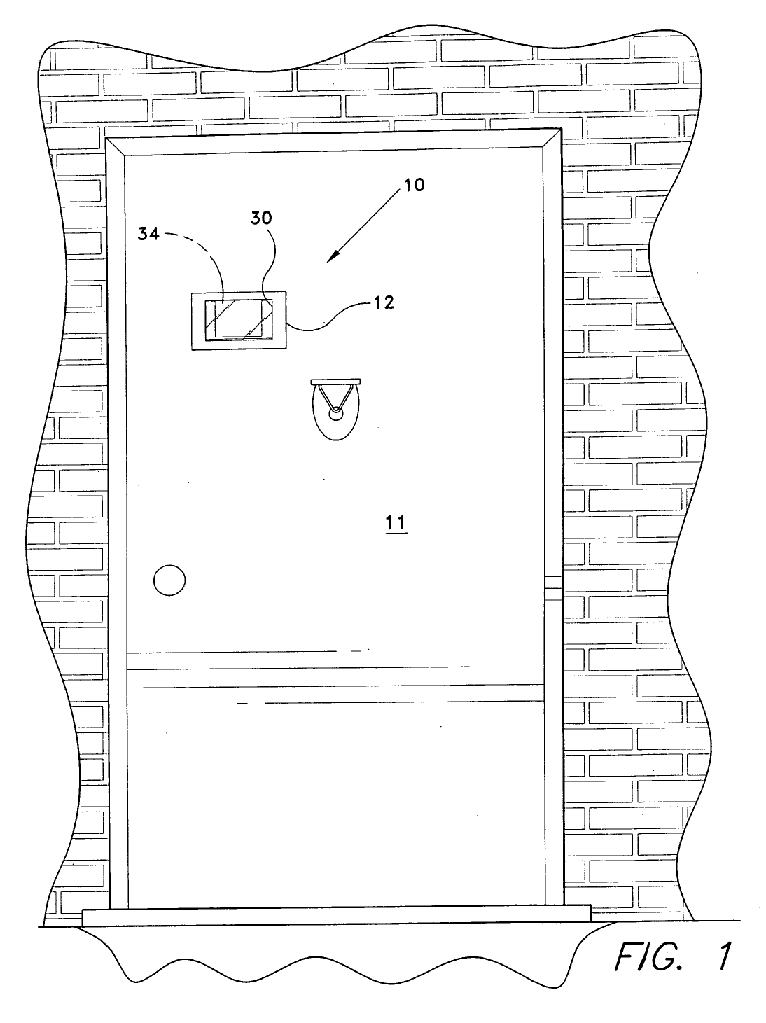

The present invention is a note box, designated generally as 10 in the drawings. As depicted in FIG. 1, the note box 10 is configured for attachment to a door 11, door frame, or other suitable vertical support structure so that visitors, delivery persons, etc., may conveniently leave a note for a resident when there is no one on the premises, or so that a resident may leave a note for the visitor, delivery person, a family member, etc.

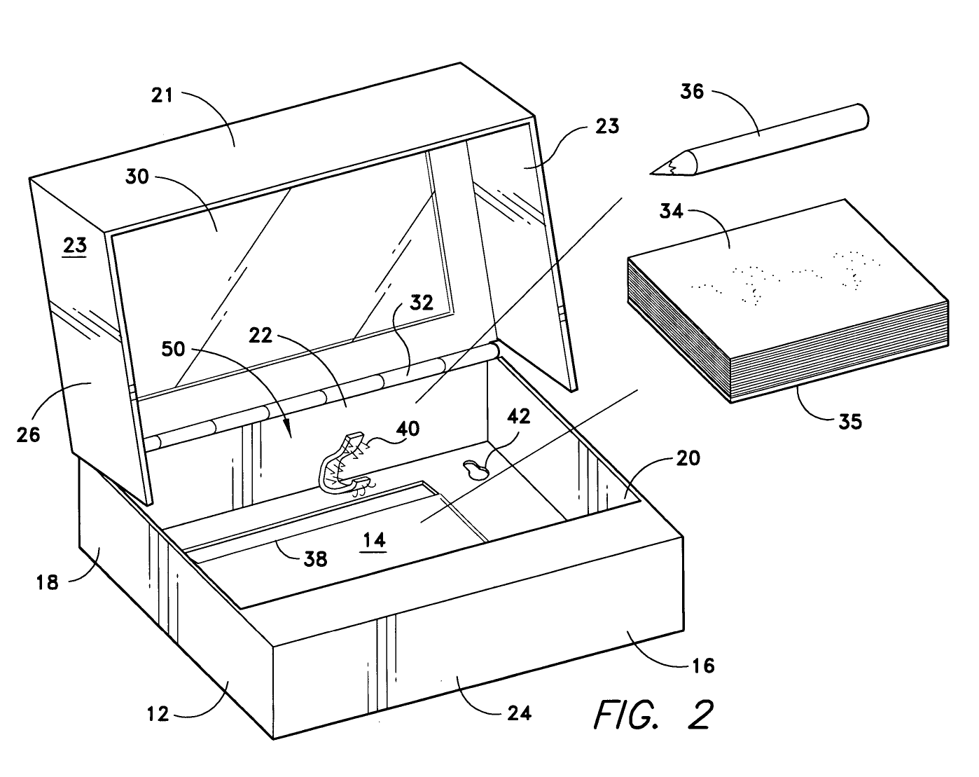

As depicted in FIG. 2, the note box 10 comprises a box-shaped housing 12 to which a door 26 is pivotally attached. The note box 10 may be of any suitable shape, however, as is shown in the drawings, a rectangular shape is preferred. The housing 12 is formed by a planar rear wall 14 and at least one upright peripheral wall 16 integrally connected to the planar rear wall 14. The peripheral wall 16 may be rectangular and may include a plurality of sidewalls 18, 20, 22, and 24 extending up from the rear wall 14. The planar rear wall 14 is connected to the peripheral wall 16 along the length of the peripheral wall 16 to form the back of the box-shaped housing 12. The rear wall 14 and the peripheral wall 16 define a compartment 50. The housing 12 may be made from any suitable waterproof material including, but not limited to, plastic and metal.

The door 26 is dimensioned and configured to close over the compartment 50 defined by the peripheral wall 16 and the rear wall 14. The door 26 may have sidewalls 21 and 23 depending from its periphery to cover the sidewalls 18, 20 and 24 of the housing 12. The door 26 includes a window 30, which is made from any suitable waterproof material that is transparent, e.g., transparent plastic. Although only a transparent window 30 is shown in the drawings, the door 26 may alternatively be made entirely from a transparent material.

The door 26 is pivotally attached to the peripheral wall 16 of the housing 12. The door 26 may be pivotally connected to the peripheral wall 16 at a top portion of the peripheral wall 16, for example along sidewall 22, or a bottom portion of the peripheral wall 16, for example along sidewall 24. The door 26 may be attached by at least one hinge 32.

A pad of paper 34 and a writing instrument 36 are secured to the planar rear wall 14 of the housing 12. A rear portion of the pad of paper 34 may be inserted through a slot 38 defined in the planar rear wall 14 in order to secure the pad 34 within the housing 12 and hold the pad 34 upright. Preferably, the pad of paper 34 has a rigid backing 35, such as cardboard, for insertion in the slot 38. Alternatively, the pad 34 may have a layer of adhesive affixed to the back of the pad 34 in order to attach to the pad 34 to the rear wall 14.

The housing 12 further includes one or more strips of hook-and-loop fastening material 40, preferably affixed to the planar rear wall 14, which may be used to attach the writing instrument 36 to the housing 12.

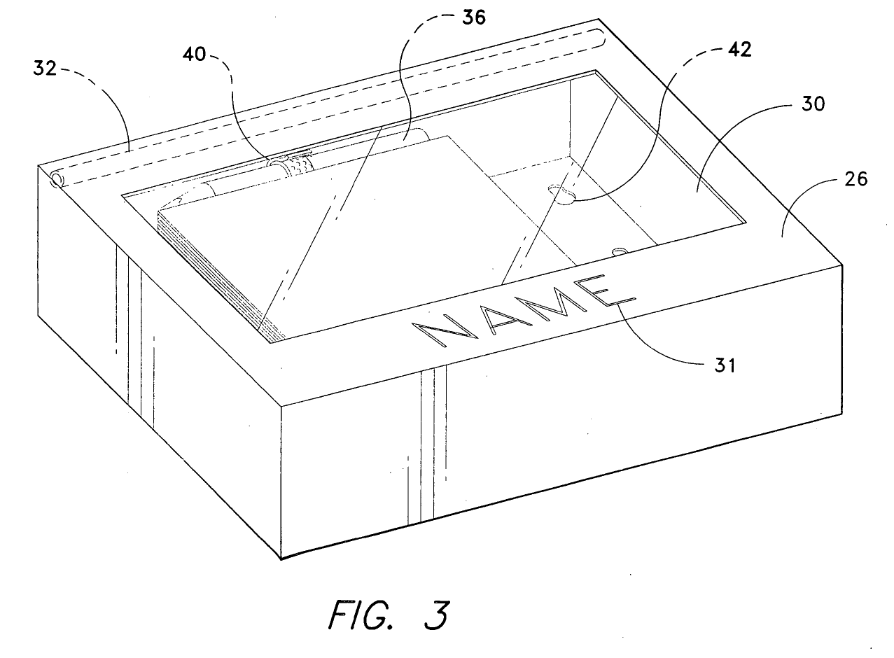

As shown in FIG. 3, when the door 26 is in the closed position, the interior of the housing 12, including the notepad 34, is visible through the window 30. Consequently, any messages or notes left in the note box 10 will be evident to the resident or visitor even when the note box 10 is closed. The door 26 may further include indicia 31, such as decorative designs and/or the name of the resident.

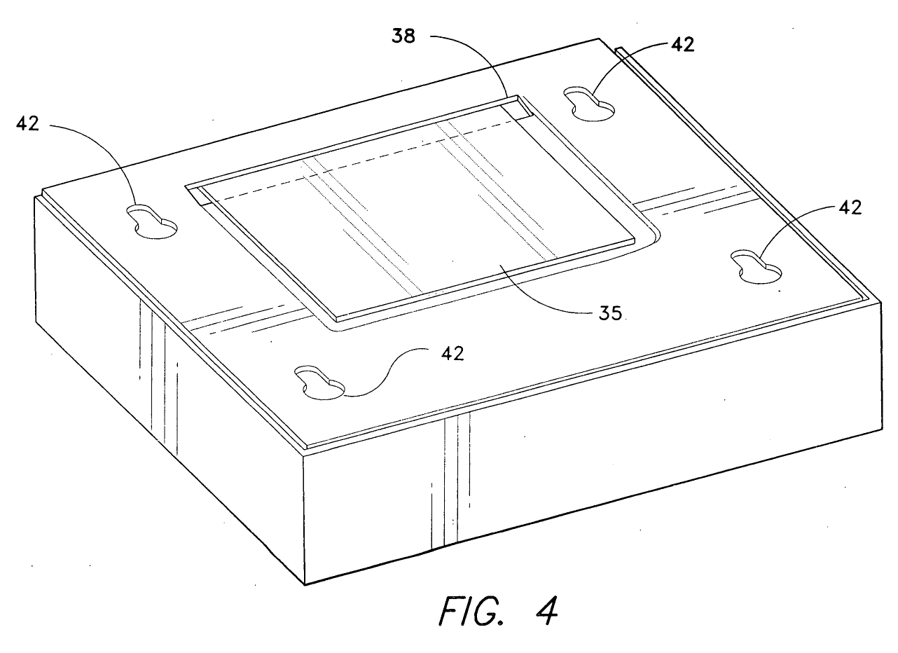

As shown in FIG. 4, the planar rear wall 14 may further include keyhole openings 42 for receiving suitable anchors, such as nails, hooks, and screws, for mounting the note box to a vertical support surface, such as the door 11 of a residence.

It is to be understood that the present invention is not limited to the embodiment described above, but encompasses any and all embodiments within the scope of the following claims.

I claim:

1. A note box, comprising:
a box-shaped housing having a planar rear wall and an upright peripheral wall extending around the planar rear wall, the peripheral wall including at least one sidewall, the peripheral wall and the rear wall defining a compartment;
a door pivotally attached to the peripheral wall, the door including a transparent window, the door covering the compartment of the housing when the door is in a closed position; and
a pad of paper removably secured to the planar rear wall within the housing.

2. The note box according to claim 1, further including a writing instrument removably secured within the housing.

3. The note box according to claim 1, wherein said planar rear wall has a slot defined therein for receiving a backing of the pad of paper.

4. The note box according to claim 1, wherein the rear wall has a plurality of keyhole apertures defined therein for attaching the housing to a vertical support.

5. The note box according to claim 2, further including at least one strip of hook-and-loop fastening material attached to the rear planar wall, the strip of hook-and-loop fastening material for securing the writing instrument to the rear wall.

6. The note box according to claim 1, wherein the door is pivotally attached to a top portion of the peripheral wall.

7. The note box according to claim 1, wherein the door is pivotally attached to a bottom sidewall of the peripheral wall.

8. The note box according to claim 1, further comprising a hinge pivotally attaching the door to the peripheral wall.

9. The note box according to claim 1, further comprising adhesive attaching pad of paper to the rear wall.

10. The note box according to claim 1, further comprising at least one strap attached to the housing, the strap having mating hook and loop fasteners attached thereto, the strap being adapted for securing a writing instrument within the housing.
